(19) United States
(12) Patent Application Publication
(10) Pub. No.: US 2009/0275374 A1
(43) Pub. Date: Nov. 5, 2009

(54) TOURNAMENT PLAY IN A GAMING PROPERTY

(75) Inventors: Loren Nelson, Reno, NV (US); Rodney E. Hill, Cumming, GA (US)

Correspondence Address: SEED INTELLECTUAL PROPERTY LAW GROUP, PLLC, 701 FIFTH AVENUE, SUITE 5400, SEATTLE, WA, 98104, US

(73) Assignee: BALLY GAMING, INC., Las Vegas, NV (US)

(21) Appl. No.: 12/112,554

(22) Filed: Apr. 30, 2008

(51) Int. Cl. A63F 13/00

(52) U.S. Cl. 463/16; 463/42

(57) ABSTRACT

A gaming property may host a tournament having a tournament duration. Tournament games having timed tournament sessions shorter than the tournament duration may be played on the gaming property, and the tournament scores achieved in the tournament games may be compared. A winning player of the tournament may then be chosen based on the comparison.

### BACKGROUND OF THE INVENTION

1. Technical Field

This description generally relates to the field of gaming properties, and more particularly to enabling tournament play in a gaming property.

2. Description of the Related Art

Traditionally, gaming properties have devoted a large percentage of floor space to gaming devices. Each gaming device presents players with individual games of chance, games of skill, or combinations thereof that a player may wager on. The player may then sit or stand in front of the gaming device, inserting his or her money, playing against the gaming device. Unfortunately, such game play is often repetitive and may become boring after the player has been playing for extended periods of time.

In response, certain gaming properties have begun to offer tournaments. Typically, a number of specialized gaming devices are set aside by the gaming property for tournament play. Players may then play against each other for prizes using these specialized gaming devices. The tournaments are typically initiated by the gaming property at a particular time, and players must know of the tournaments ahead of time if they would like to compete. Moreover, all of the competing players must arrange their schedules to be at the gaming property at the same time.

It would be desirable to offer improved tournament play in gaming properties.

### BRIEF SUMMARY

In one embodiment, a system for enabling tournament play in a gaming property comprises a plurality of gaming devices, each of the plurality of gaming devices including a game display and configured to enable play of at least one game of chance, a server coupled to the plurality of gaming devices, and a display board coupled to the server. The server may include a processor that executes instructions, and a computer-readable memory that stores instructions that cause the processor to enable tournament play by: initiating a tournament having a tournament duration within the gaming property; causing tournament icons to be displayed on the game displays of the plurality of gaming devices during play of the at least one game of chance; enabling play of a tournament game associated with the tournament at the plurality of gaming devices, the tournament game comprising a timed tournament session shorter than the tournament duration; receiving tournament scores achieved in the tournament game during the tournament duration from the plurality of gaming devices; comparing the tournament scores; and determining a winning player based at least in part on the comparison. The display board may be viewable by players of the plurality of gaming devices and may be configured to display at least one of the tournament scores during the tournament duration.

In another embodiment, a computer-implemented method for enabling tournament play in a gaming property comprises: initiating a tournament having a tournament duration at a gaming property; enabling play of a tournament game associated with the tournament at a plurality of gaming devices in the gaming property, the tournament game comprising a timed tournament session shorter than the tournament duration; receiving tournament scores achieved in the tournament game during the tournament duration from the plurality of gaming devices; comparing the tournament scores; and determining a winning player based at least in part on the comparison.

In yet another embodiment, a server for enabling tournament play in a gaming property comprises a processor that executes instructions, and a computer-readable memory that stores instructions that cause the processor to enable tournament play by: initiating a tournament having a tournament duration at a gaming property; enabling play of a tournament game associated with the tournament at a plurality of gaming devices in the gaming property, the tournament game comprising a timed tournament session shorter than the tournament duration; receiving tournament scores achieved in the tournament game during the tournament duration from the plurality of gaming devices; comparing the tournament scores; and determining a winning player based at least in part on the comparison.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a high-level schematic view of a gaming property including a server coupled to a plurality of gaming devices, according to one illustrated embodiment.

FIG. 2 is a perspective view of one of the gaming devices of FIG. 1, according to one illustrated embodiment.

FIG. 3 is a schematic view of the gaming device of FIG. 2, according to one illustrated embodiment.

FIG. 4 is an image representing a game display of the gaming device of FIG. 2 during play of a non-tournament game, according to one illustrated embodiment.

FIG. 5 is an image representing the game display of the gaming device of FIG. 2 during play of a tournament game, according to one illustrated embodiment.

FIG. 6 is a schematic view of the server of FIG. 1, according to one illustrated embodiment.

FIG. 7 is a flow diagram illustrating a method for enabling tournament play in a gaming property, according to one illustrated embodiment.

### DETAILED DESCRIPTION OF EMBODIMENTS OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and methods associated with gaming properties, servers, gaming devices, games of chance and network communications have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Exemplary Gaming Property

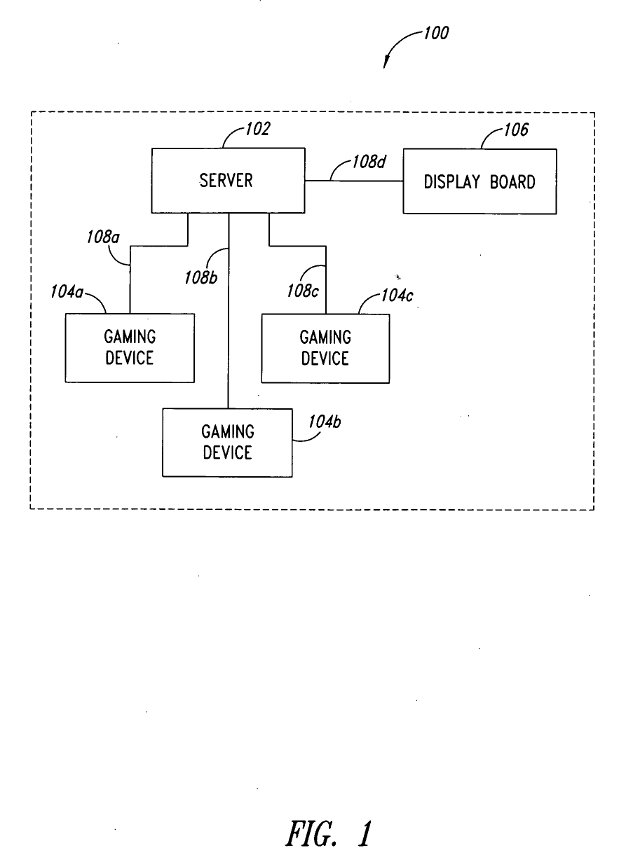

FIG. 1 shows a gaming property 100 including a server 102 communicatively coupled to a plurality of gaming devices 104a-c (collectively 104) and to a display board 106. Although only three gaming devices 104 are illustrated in FIG. 1, it may be understood that more or fewer gaming devices may be included in different embodiments.

The gaming property 100 may comprise any of a variety of establishments housing a plurality of gaming devices 104 used for gaming/gambling. In one embodiment, the gaming property 100 may be a casino. However, even convenience stores or gas stations having one or more gaming devices may be a gaming property 100. In one embodiment, the gaming property 100 may comprise a single building including at least one room housing the gaming devices 104.

As illustrated, a network may be formed within the gaming property 100 between the server 102, the gaming devices 104, and the display board 106. Logical connections 108a-d (collectively 108) may be formed between these nodes. This gaming network may comprise any of a variety of networks and related hardware and/or software. The network may comprise a wired or wireless enterprise-wide computer network, intranet, extranet or the Internet. Other embodiments may be implemented in other types of communication networks, including telecommunications networks, cellular networks, and other mobile networks. The illustrated logical connections 108 may be wired or wireless and may employ any of a variety of network protocols.

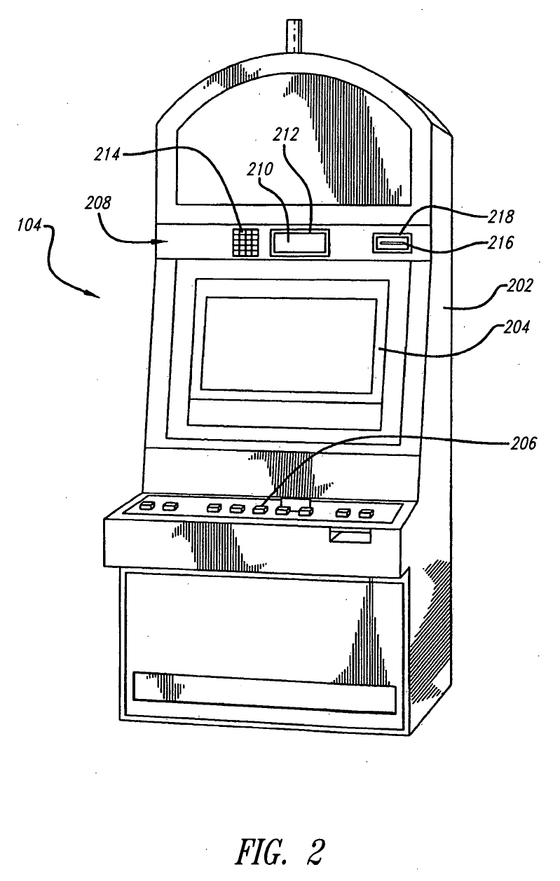

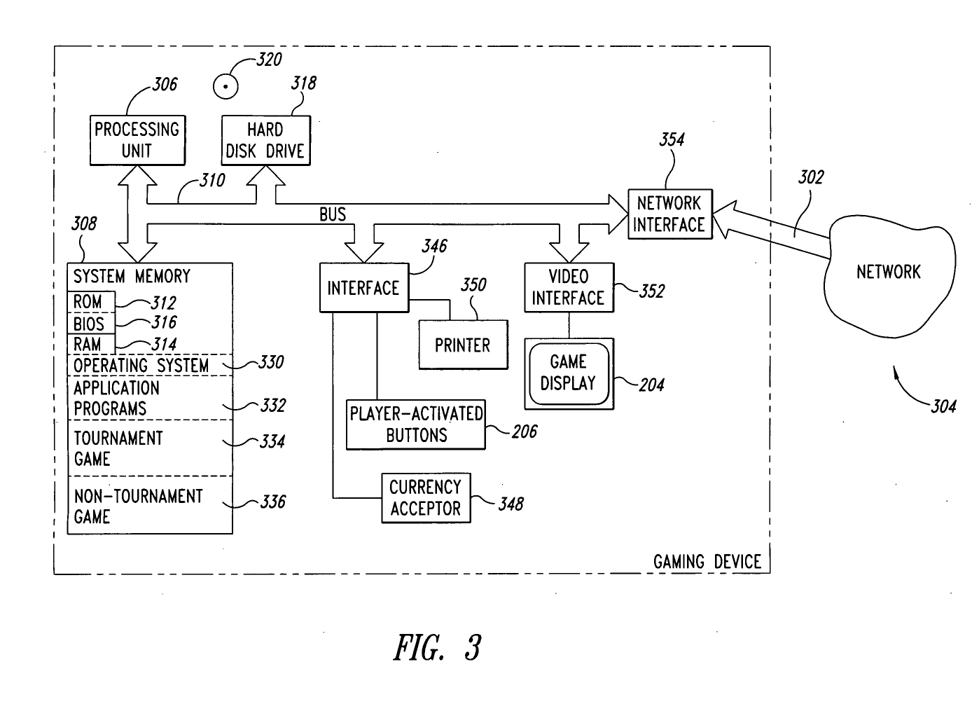

The gaming devices 104 may comprise electronic devices offering games of chance, games of skill, or combinations thereof that a player may wager on. The gaming devices 104 may have a variety of configurations, but one example structure and configuration for the gaming devices 104 is discussed in greater detail with respect to FIGS. 2 and 3.

In one embodiment, each gaming device 104 may be configured to enable play of one or more non-tournament games of chance, such as mechanical slots, video slots, video keno, video poker, mechanical or video roulette, etc. For each play of the non-tournament game of chance (e.g., a spin of the slots), a player may wager some number of credits representing an amount of money, and, depending upon the outcome, the player may win or lose credits. In one embodiment, although the server 102 (or another computing device) may collect information from the gaming devices 104, including wagers, player activity, or progressive jackpot entries, the non-tournament games of chance may not provide explicit competition between players of the gaming devices 104.

The gaming devices 104 may be further configured to enable play of at least one tournament game. In one embodiment, the tournament game may be associated with a tournament initiated by the server 102. Scores achieved by players of the tournament game may be sent to the server 102 where they may be compared, and prizes may then be awarded to players achieving high scores in the tournament game.

In one embodiment, the tournament game may comprise a timed tournament session. In order to give players greater flexibility in playing in the tournament, the duration of the tournament itself (i.e., the time during which tournament entries are accepted by the server 102) may be longer than the timed tournament session. Thus, different players may play the tournament game at different times during the tournament duration.

In one embodiment, the gaming devices 104 may charge a flat tournament fee to players desiring to play the tournament game. This tournament fee may allow a player to play a single timed tournament session. In another embodiment, the player may pay a first fee in order to play the tournament game on the gaming device 104 but may then be required to pay a second fee in order to submit a score achieved in the tournament game to the server 102.

The tournament game may be similar to any one of the non-tournament games offered on the gaming devices 104 or may be a different game. In one embodiment, the tournament game may be a game of chance, such as video slots, video keno, video poker, video roulette, BLAZING 7's (offered by Bally Technologies, Inc.), etc. In another embodiment, the tournament game may comprise a game of skill or a game of chance involving some player skill.

The gaming devices 104 may enable players to choose between non-tournament games and tournament games. For example, as described in greater detail below, the gaming devices 104 may display a selectable tournament icon representing the tournament game while the player is playing a non-tournament game of chance. In another embodiment, a menu may be displayed on the gaming device 104, the menu including a variety of non-tournament and tournament icons and allowing a patron to select between non-tournament games and tournament games.

The server 102 may function as a central communications and information gathering hub for tournament play within the gaming property 100. In one embodiment, the server 102 may initiate a tournament and may then compare tournament scores received from the gaming devices 104. In other embodiments, the server 102 may also receive player identifiers from the gaming devices 104, each of the player identifiers associated with a respective tournament score. The server 102 may then determine at least one winning player based upon the comparison of the tournament scores.

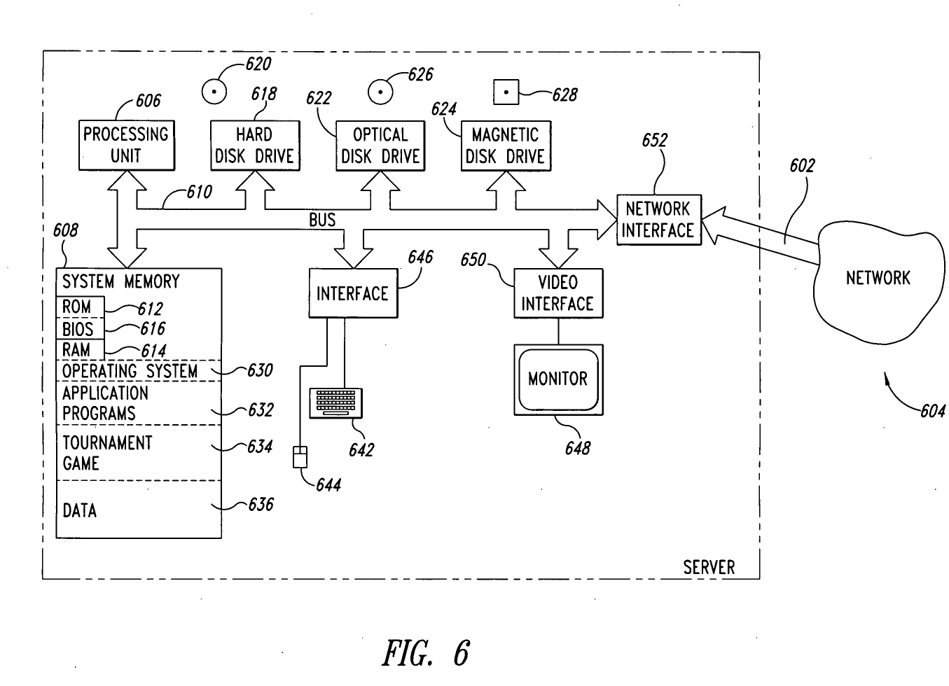

The server 102 may be implemented in any of a variety of types of hardware. One example server 102 is described in greater detail below with reference to FIG. 6.

The display board 106 may also be coupled to the server 102 and may be configured to display information associated with the tournament. In one embodiment, the display board 106 may comprise a computing device coupled to a large display visible to a plurality of players within the gaming property 100. Information sent from the server 102 may be processed by the display board 106 and then displayed. In another embodiment, the display board 106 may simply comprise a large display coupled directly to a video output of the server 102 or another computing device within the gaming property 100.

In one embodiment, the display board 106 may display at least one of the tournament scores during the tournament duration. For example, the display board 106 may display a current high score in the tournament. This high score may encourage players throughout the gaming property 100 to enter the tournament. In another embodiment, the display board 106 may display other information, such as a list of scoring leaders or the first name of the player that currently holds the high score. The display board 106 may be positioned such that it is viewable by players engaging the plurality of gaming devices 104.

### Description of a Suitable Gaming Device

Referring to FIG. 2, one example embodiment of a gaming device 104 will be described in greater detail. As illustrated, the gaming device 104 includes a housing 202, a game display 204, a plurality of player-activated buttons 206, and a player interaction system 208. The housing 202 may be a self-standing unit that is generally rectangular in shape. In other embodiments, the housing may comprise a slant-top, bar-top, or table-top style cabinet. However, any shaped housing may be used with embodiments of the gaming device 104.

The game display 204 may present one or more non-tournament games of chance, such as, but not limited to, mechanical slots, video slots, video keno, video poker, mechanical or video roulette, Class II bingo, lottery, craps, blackjack, a mechanical or video representation of a wheel game, etc. One example game of chance is BLAZING 7's by Bally Technologies, Inc. In other embodiments, the game display 204 may present non-tournament games of skill or non-tournament games of chance involving some player skill.

The game display 204 may also present one or more tournament games of chance, tournament games of skill and/or tournament games of chance involving some player skill. The tournament games of chance may include mechanical slots, video slots, video keno, video poker, mechanical or video roulette, Class II bingo, lottery, craps, blackjack, or a mechanical or video representation of a wheel game.

In one embodiment, the game display 204 is a CRT or a panel display, such as, but not limited to, liquid crystal, plasma, electroluminescent, vacuum fluorescent, field emission, or any other type of panel display. Additionally, the game display 204 may also include a touch screen or touch glass system.

As shown in FIG. 2, one embodiment of the player interaction system 208 comprises a graphics display 210, a touch bezel 212, a keypad 214, a player club card reader 216, and a card reader bezel 218. The graphics display 210 may display any visual screen images (e.g., pictures, characters, symbols) and video images that have been converted for compatibility with digital or computer manipulation, transport and storage. The player interaction system 208 may be positioned above the game display 204, as shown in FIG. 2. Alternatively, the player interaction system 208 may be positioned below or next to the game display 204 or in any other location.

In one embodiment, the player club card reader 216 may read magnetic stripe cards. In this regard, the player club card reader 216 may be used to read player club cards issued by a gaming property, gaming property employee cards, smart cards, and the like. Generally, the player club card reader 216 may monitor and track player and employee activity each time a player or employee inserts his or her card into the player club card reader 216. In addition, the player club card reader 216 may be used to associate tournament scores with player accounts, as described in greater detail below.

The gaming device 208 may further include a voucher printer (not shown) that prints to and then dispenses vouchers via a voucher slot 220. The voucher printer may comprise any of a variety of printers configured to encode vouchers that may be redeemed by a player. For example, in one embodiment, the voucher printer may not print human-readable information, but instead may transmit electromagnetic signals to a radio frequency identification tag on a voucher in order to encode information to the voucher. Of course, in other embodiments, other mechanisms for paying out players may be provided, including a coin hopper, a device for electronic funds transfer, etc.

With reference to FIG. 3, the internal structure of the gaming device 104 may be described in greater detail. Although not required, the embodiments will be described in the general context of computer-executable instructions, such as program application modules, objects, or macros being executed by a computer. The embodiments can be practiced in distributed computing environments where tasks or modules are performed by remote processing devices, which are linked through a communications network. In a distributed computing environment, program modules may be located in both local and remote memory storage devices.

FIG. 3 shows a gaming device 104. The gaming device 104 is coupled by at least one communication channel/logical connection 302 to a network 304. This logical connection 302 may serve as any one of the logical connections 108 illustrated in FIG. 1 communicatively coupling the gaming devices 104 to the server 102.

The gaming device 104 may have an internal configuration similar to that of a conventional PC, which includes a processing unit 306, a system memory 308 and a system bus 310 that couples various system components including the system memory 308 to the processing unit 306. The gaming device 104 will at times be referred to in the singular herein, but this is not intended to limit the embodiments to a single processor. Non-limiting examples of commercially available systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 306 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 3 are of conventional design. As a result, such blocks need not be described in further detail herein, as they will be understood by those skilled in the relevant art.

The system bus 310 can employ any known bus structures or architectures, including a memory bus with memory controller, a peripheral bus, and a local bus. The system memory 308 includes read-only memory (“ROM”) 312 and random access memory (“RAM”) 314. A basic input/output system (“BIOS”) 316, which can form part of the ROM 312, contains basic routines that help transfer information between elements within the gaming device 104, such as during start-up.

The gaming device 104 may also include a hard disk drive 318 for reading from and writing to a hard disk 320. The hard disk drive 318 may communicate with the processing unit 306 via the system bus 310. The hard disk drive 318 may also include an interface or controller (not shown) coupled between it and the system bus 310, as is known by those skilled in the relevant art. The hard disk drive 318 provides nonvolatile storage for computer-readable instructions, data structures, program modules and other data for the gaming device 104. Although the depicted gaming device 104 employs a hard disk 320, those skilled in the relevant art will appreciate that other types of computer-readable media that can store data accessible by a computer may be employed, such as magnetic cassettes, flash memory cards, Bernoulli cartridges, RAMs, ROMs, smart cards, optical disks, magnetic disks, etc.

Program modules can be stored in the system memory 308, such as an operating system 330, one or more application programs 332, one or more tournament games 334, and one or more non-tournament games 336. The system memory 308 may also include communications programs permitting the gaming device 104 to access and exchange data over networks.

While shown in FIG. 3 as being stored in the system memory 308, the operating system 330, application programs 332, tournament games 334 and non-tournament games 334 can be stored on the hard disk 320 of the hard disk drive 318.

A player can interact with the gaming device 104 through input devices such as player-activated buttons 206. Other input devices can include a touch-sensitive bezel 212, joystick, game pad, tablet, scanner, etc. These and other input devices may be connected to the processing unit 306 through an interface 346 such as a universal serial bus (“USB”) interface that couples to the system bus 310, although other interfaces such as a parallel port, a game port or a wireless interface or a serial port may be used.

The interface 346 may further be coupled to a currency acceptor 348 configured to accept currency from a patron. In one embodiment, the currency acceptor 348 may include one or more coin slots, bill acceptors, etc. In another embodiment, the gaming device 104 may include a card slot for receiving a financial card issued by a financial institution, via which credits may be purchased.

A game display 204 or other display device may be coupled to the system bus 310 via a video interface 352, such as a video adapter.

The interface 346 may further be coupled to a voucher printer 350. As described above, the voucher printer 350 may comprise any of a variety of printers configured to encode and dispense vouchers. In one embodiment, the voucher printer 350 may print vouchers in accordance with instructions received via a network interface 354.

The gaming device 104 operates in a networked environment using one or more logical connections 302 to communicate with one or more remote computers, servers and/or devices through the network 304. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, and other mobile networks.

In one embodiment, the network interface 354 (communicatively linked to the system bus 310) may be used for establishing communications over the logical connection 302. In a networked environment, program modules, application programs, or games, or portions thereof, can be stored outside of the gaming device 104 (not shown). Those skilled in the relevant art will recognize that the network connections shown in FIG. 3 are only some examples of ways of establishing communications between computers, and other connections may be used.

Further information regarding potential configurations for the gaming device 104 may be found in commonly assigned, co-pending U.S. patent application Ser. No. ______, titled GAMING DEVICE HAVING TWO CARD READERS, attorney docket no. 110184.451, filed Apr. 30, 2008, the contents of which are hereby incorporated herein in their entirety.

### Description of Exemplary Non-Tournament and Tournament Games

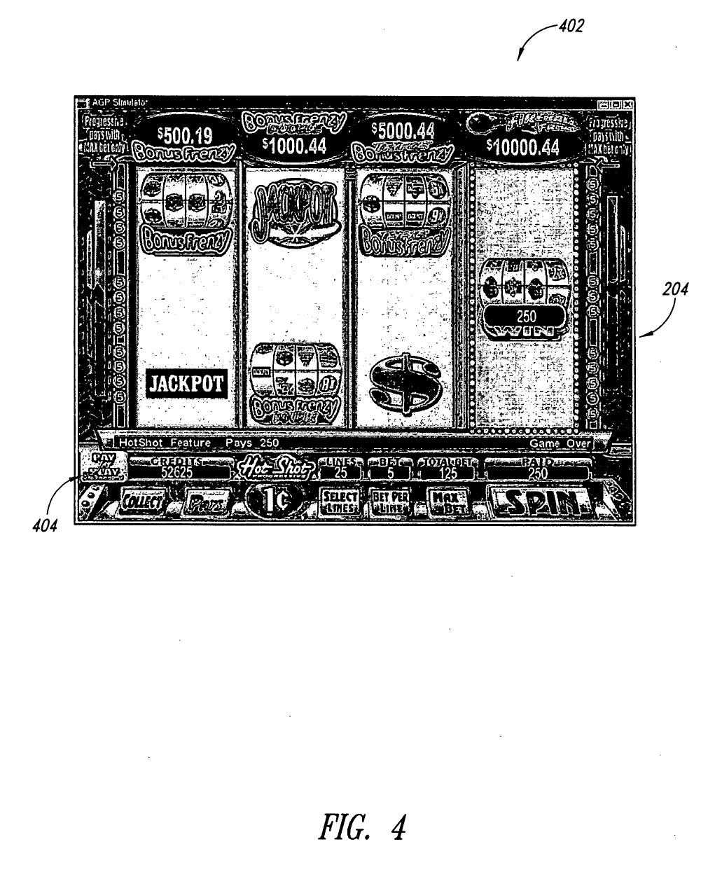

FIG. 4 illustrates a screenshot of the game display 204 of the gaming device 104. In one embodiment, a non-tournament game of chance 402 may be displayed on the game display 204, and a player may interact with the gaming device 104 (e.g., via a touch screen) in order to play the non-tournament game 402. As illustrated, the non-tournament game of chance 402 is a video slot game. However, in other embodiments, different non-tournament games of chance as well as non-tournament games of skill may be played on the gaming device 104.

As described above, the player may wager some number of credits representing an amount of money on each play of the non-tournament game 402. Depending upon the outcome of the non-tournament game 402, the player may then win or lose credits. For example, as illustrated, the player may place a number of bets on pay lines (not shown) associated with the non-tournament game 402, wherein each of the bets is worth one penny. In FIG. 4, the player has just completed a play in which he or she bet $1.25 and won $2.50.

In one embodiment, the non-tournament game of chance 402 does not provide for any explicit competition between the different gaming devices and corresponding players. For example, the scores achieved in the non-tournament game of chance 402 on the plurality of gaming devices 104 may not be compared by the server 102 in order to award a cash prize.

As illustrated, while a player plays the non-tournament game 402, a tournament icon 404 may be simultaneously displayed on the game display 204. In one embodiment, upon initiating a tournament, the server 102 may send a request to the gaming devices 104 causing tournament icons 404 to be displayed on corresponding game displays 204. In another embodiment, the tournament icons 404 may be displayed on the game displays 204 by default, and, when a tournament is not being hosted at the gaming property 100, the server 102 may request that the gaming devices 104 not display the tournament icon 404. In yet another embodiment, the tournament icon 404 may be relatively permanently displayed but may only be selectable during a tournament.

In one embodiment, the tournament icon 404 may be selected by a player at any point during display of the non-tournament game 402. The player may touch the game display 204 to select the tournament icon 404 or use another user input device to highlight and select the tournament icon 404. Upon selection of the tournament icon 404, play of the non-tournament game 402 may be ended, and play of a tournament game may be initiated by the gaming device 104.

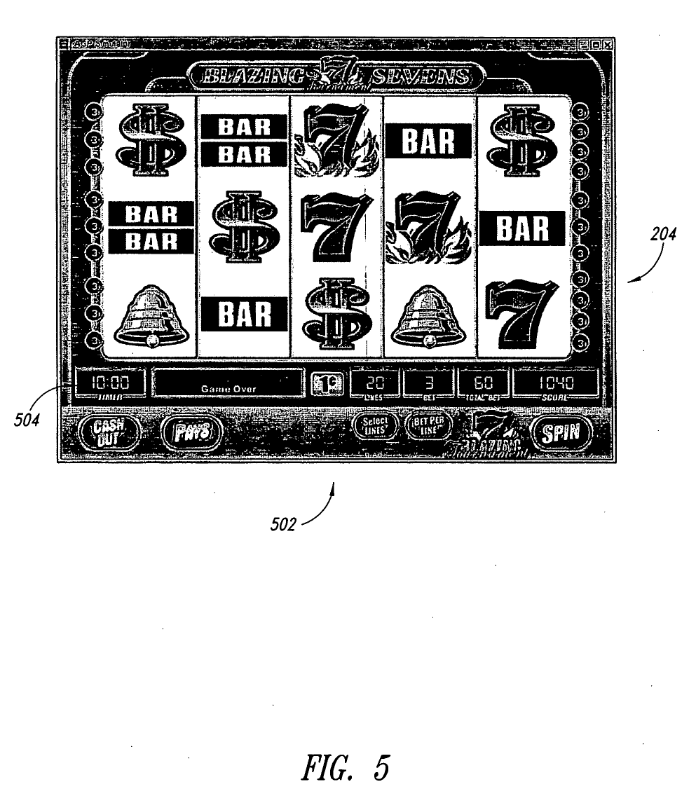

FIG. 5 illustrates another screenshot of the game display 204. In one embodiment, a tournament game of chance 502 may be displayed on the game display 204, and a player may interact with the gaming device 104 in order to play the tournament game 502. As illustrated, the tournament game of chance 502 is a video slot game, BLAZING 7's by Bally Technologies, Inc. However, in other embodiments, different tournament games of chance and/or tournament games of chance involving some player skill may be played on the gaming device 104.

In one embodiment, the gaming device 104 may charge a player a tournament fee in order to play the tournament game. If the player has sufficient credits, the tournament fee may be subtracted from the credits already loaded onto the gaming device 104. Otherwise, the gaming device 104 may request that the player insert more money in order to pay the tournament fee.

Much of the game play for the tournament game 502 may be similar to that for a non-tournament game. For example, the player may have the choice of how many and which pay lines to bet, how much to bet, etc. However, in one embodiment, the tournament game 502 may be played for a timed tournament session, as indicated by the timer 504. Rather than wagering credits corresponding to an amount of money, a player may play the tournament game 502 for the timed tournament session in order to achieve a high score in comparison with tournament scores achieved by other players.

After the timed tournament session has expired, the gaming device 104 may send the tournament score achieved by the player to the server 102, and, once the tournament has ended, it may be determined whether or not the player is among the winning players in the tournament.

In one embodiment, the gaming device 104 may dispense a tournament voucher to the player after the timed tournament session. This tournament voucher may then be redeemed for a prize if the player is one of the winning players in the tournament. In another embodiment, if the player is still prsent at the gaming device 104, the game display 204 may display an indication that the player has won the tournament. In yet another embodiment, winning players of the tournament may be displayed on the display board 106, and a cash prize may be automatically credited to a player account at the gaming property 100.

### Description of a Suitable Server

FIG. 6 and the following discussion provide a brief, general description of a suitable server 102 for use in the gaming property 100. Although not required, the embodiments will be described in the general context of computer-executable instructions, such as program application modules, objects, or macros being executed by a computer. Those skilled in the relevant art will appreciate that the illustrated embodiments as well as other embodiments can be practiced with other computer system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

FIG. 6 shows a server 102. The server 102 is coupled by at least one communication channel/logical connection 602 to a network 604. This logical connection 602 may serve as any one of the logical connections 108 illustrated in FIG. 1 communicatively coupling the server 102 to the gaming devices 104 and to the display board 106.

The server 102 may take the form of a conventional PC, which includes a processing unit 606, a system memory 608 and a system bus 610 that couples various system components including the system memory 608 to the processing unit 606. The server 102 will at times be referred to in the singular herein, but this is not intended to limit the embodiments to a single server computer, since in certain embodiments, there will be more than one server or other networked computing device involved. Non-limiting examples of commercially available systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 606 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 6 are of conventional design. As a result, such blocks need not be described in further detail herein, as they will be understood by those skilled in the relevant art.

The system bus 610 can employ any known bus structures or architectures, including a memory bus with memory controller, a peripheral bus, and a local bus. The system memory 608 includes read-only memory (“ROM”) 612 and random access memory (“RAM”) 614. A basic input/output system (“BIOS”) 616, which can form part of the ROM 612, contains basic routines that help transfer information between elements within the server 102, such as during start-up.

The server 102 may also include a hard disk drive 618 for reading from and writing to a hard disk 620, and an optical disk drive 622 and a magnetic disk drive 624 for reading from and writing to removable optical disks 626 and magnetic disks 628, respectively. The optical disk 626 can be a CD or a DVD, while the magnetic disk 628 can be a magnetic floppy disk or diskette. The hard disk drive 618, optical disk drive 622 and magnetic disk drive 624 communicate with the processing unit 606 via the system bus 610. The hard disk drive 618, optical disk drive 622 and magnetic disk drive 624 may include interfaces or controllers (not shown) coupled between such drives and the system bus 610, as is known by those skilled in the relevant art. The drives 618, 622, 624, and their associated computer-readable media 620, 626, 628, provide nonvolatile storage of computer-readable instructions, data structures, program modules and other data for the server 102. Although the depicted server 102 employs hard disk 620, optical disk 626 and magnetic disk 628, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

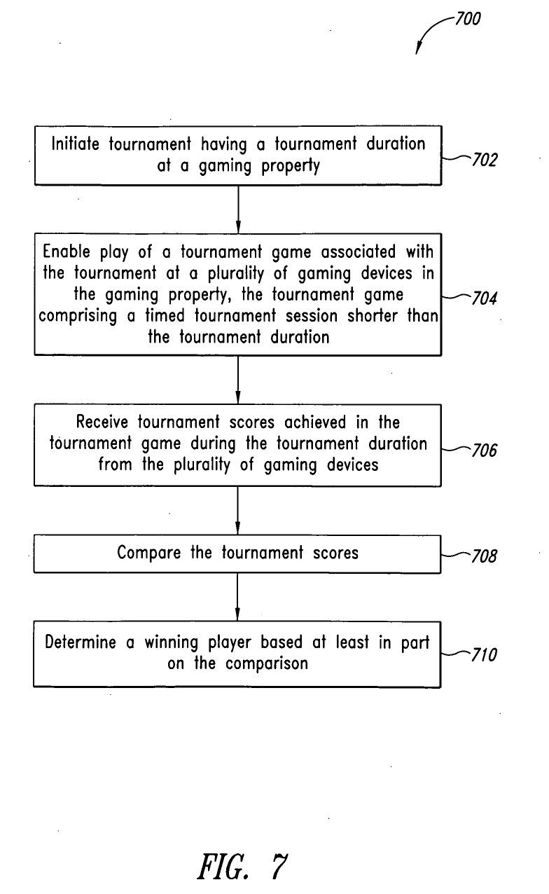

Program modules can be stored in the system memory 608, such as an operating system 630, one or more application programs 632, at least one tournament game 634, and data 636. As described in greater detail with reference to FIG. 7, the data 636 may include tournament scores received from the gaming devices 104, and it may be understood that the tournament game 634 may be distributed to the gaming devices 104 in a distributed computing environment. The system memory 608 may also include communications programs for permitting communications over a network.

While shown in FIG. 6 as being stored in the system memory 608, the operating system 630, application programs 632, tournament game 634, and data 636 can be stored on the hard disk 620 of the hard disk drive 618, the optical disk 626 of the optical disk drive 622 and/or the magnetic disk 628 of the magnetic disk drive 624.

A user can enter commands and information into the server 102 through input devices such as a touch screen or keyboard 642 and/or a pointing device such as a mouse 644. Other input devices can include a microphone, joystick, game pad, tablet, scanner, etc. These and other input devices may be connected to the processing unit 606 through an interface 646 such as a universal serial bus (“USB”) interface that couples to the system bus 610, although other interfaces such as a parallel port, a game port or a wireless interface or a serial port may be used. A monitor 648 or other display device is coupled to the system bus 610 via a video interface 650, such as a video adapter. Although not shown, the server 102 can include other output devices, such as speakers, printers, etc.

The server 102 operates in a networked environment using one or more logical connections 602 to communicate with one or more remote computers, servers and/or other computing devices through the network 604. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, and other mobile networks.

In one embodiment, a network interface 652 (communicatively linked to the system bus 610), may be used for establishing communications over the logical connection 602. In a networked environment, program modules, application programs, tournament games, or data, or portions thereof, can be stored outside of the server 102 (not shown). Those skilled in the relevant art will recognize that the network connections shown in FIG. 6 are only some examples of ways of establishing communications between computers, and other connections may be used.

### Description of an Exemplary Method for Enabling Tournament Play

FIG. 7 illustrates a flow diagram for a method 700 of enabling tournament play, according to one embodiment. This method 700 will be discussed in the context of the gaming property 100 of FIG. 1. However, it may be understood that the acts disclosed herein may be executed in a variety of different gaming properties and even between multiple gaming properties, in accordance with the described method.

The method begins at 702, when a tournament having a tournament duration is initiated at a gaming property 100. In one embodiment, the tournament may be initiated by the server 102, and the server 102 may begin accepting tournament entries from the plurality of gaming devices 104 communicatively coupled thereto (as described below with reference to act 706). The server 102 may be programmed to automatically begin the tournament at a predetermined time, or an employee of the gaming property 100 may manually cause the server 102 to initiate the tournament.

In one embodiment, the server 102 may send a tournament message to the plurality of gaming devices 104 indicating that the tournament has begun. The server 102 may cause a tournament screen to briefly display on the game displays 204 of the gaming devices 104 or may cause lights on the gaming devices 104 to flash. In another embodiment, the server 102 may cause the display board 106 to display a new tournament notification or may cause a tournament announcement to be made in the gaming property 100. In other embodiments, tournaments in the gaming property 100 may be continuous, with one tournament initiating as another ends. Thus, in some embodiments, the server 102 may simply reset a timer associated with the tournament or may begin associating new tournament scores received from the gaming devices 104 with the newly initiated tournament.

The tournament may last for any tournament duration. In one embodiment, the tournament duration may be a set length of time. For example, the tournament duration may comprise some number of weeks, days, hours, or even minutes. In another embodiment, the tournament duration may vary depending upon the number of tournament entries received. For example, the tournament may end more quickly if many players have entered in order to keep the players' odds relatively consistent across different tournaments.

At act 704, play of a tournament game associated with the tournament is enabled at a plurality of gaming devices 104 in the gaming property 100, the tournament game comprising a timed tournament session shorter than the tournament duration. In one embodiment, once the tournament has been initiated, the server 102 may send messages to the gaming devices 104 enabling play of a tournament game of chance (e.g., tournament game 502). The gaming devices 104 may already have the tournament game stored thereon, or the server 102 may distribute the tournament game to the gaming devices 104 over the network in order to enable game play. In another embodiment, tournaments in the gaming property 100 may be continuous, with one tournament initiating as another ends. In such an embodiment, play of the tournament game on the gaming devices 104 may be permanently enabled.

The server 102 may also cause tournament icons to be displayed on the game displays 204 of the gaming devices 104 during play of at least one non-tournament game of chance. As illustrated in FIG. 4, these tournament icons may be selected by players of the gaming devices 104 in order to initiate the tournament game. In one embodiment, the server 102 may send a message to the gaming devices 104 causing the gaming devices 104 to display a tournament icon previously stored on the gaming devices 104. In another embodiment, the server 102 may distribute the tournament icon to the gaming devices 104 upon initiation of the tournament.

As described above, the tournament game may comprise a timed tournament session shorter than the tournament duration. Thus, many tournament games may be played at the plurality of gaming devices 104 during the tournament, and the tournament games need not be played simultaneously.

In one embodiment, the tournament game may be the same on each of the plurality of gaming devices 104. For example, each of the gaming devices 104 may offer a timed tournament session of BLAZING 7's. In another embodiment, although the tournament game may be the same on each of the plurality of gaming devices 104, different variables may be used on the different gaming devices 104. For example, players recognized as frequent participants may be given a longer timed session, or may be given slightly better odds in the tournament. In other embodiments, the tournament game may be chosen from a variety of comparable games, and the tournament scores may be weighted or otherwise normalized for subsequent comparison by the server 102.

The tournament game may also be chosen independently of and may be different than the non-tournament games of chance played on the gaming devices 104. However, in other embodiments, the tournament game may be selected based at least in part on the non-tournament games of chance played on the gaming devices 104. For example, the tournament game may be selected to correspond to a most popular non-tournament game of chance in order to entice more players to participate in the tournament.

In one embodiment, once play has been enabled, a number of players may select the tournament icon displayed on the gaming devices 104 in order to play the tournament game. As described above, tournament fees may be charged at the gaming devices 104 for play of the tournament game. In one embodiment, a gaming device 104 may also request that a player insert his or her player club card into the player club card reader 216, such that a score achieved in the tournament game may be associated with the player's account at the gaming property 100.

Upon selection of the tournament icon, a gaming device 104 may also save information indicative of a current non-tournament game being played on the gaming device 104. For example, information indicative of a player's credits, bonuses, or wagering activity may be stored on the gaming device 104 until the tournament game ends and the non-tournament game can be resumed.

At 706, tournament scores achieved in the tournament game during the tournament duration are received from the plurality of gaming devices 104. In one embodiment, after a player has played the tournament game, the gaming device 104 may send a tournament score to the server 102. In other embodiments, the server 102 may also receive player identifiers from the gaming devices 104. For example, if a player club card has been read at the gaming device 104, a player identifier encoded on the player club card may be forwarded with the tournament score.

In another embodiment, tournament scores may be saved on the gaming devices 104 until the end of the tournament duration, and the server 102 may then receive tournament scores from all of the gaming devices.

In one embodiment, after play of the tournament game, the gaming device 104 may also print a tournament voucher for the player. The tournament voucher may be encoded with a variety of information, and information indicative of the voucher may be stored on the server 102 in association with the tournament score achieved by the player. In one embodiment, the information encoded on the voucher may include a voucher identifier (which may uniquely identify the tournament voucher) and may include an indication of the tournament score. Upon completion of the tournament duration, the tournament voucher may be redeemable at the gaming property 100 for a cash prize (provided that the player is a winning player). In another embodiment, the tournament voucher may be redeemable for some other prize, such as credits at the gaming property 100 or discounts off services provided at the gaming property 100.

In one embodiment, as tournament scores are received at the server 102, the server 102 may cause at least one of the scores to be displayed on the display board 106. For example, a current high score may be displayed on the display board 106, and this display may encourage other players to enter the tournament. In another embodiment, the tournament scores may be displayed on the display board 106 along with a first name of a corresponding player.

At 708, the tournament scores are compared. In one embodiment, the server 102 may continuously compare tournament scores as they are received from the gaming devices 104. In such an embodiment, the server 102 may continuously track current high scores and may display such scores on the display board 106. In another embodiment, the server 102 may compare the tournament scores only at the end of the tournament.

At 710, a winning player is determined based at least in part on the comparison. In one embodiment, the server 102 may determine at least one winning player of the tournament based upon a highest (or lowest) score achieved in the tournament game. In some embodiments, more than one winner of the tournament may be chosen. For example, prizes may be given to first through third place.

In one embodiment, the server 102 may associate a voucher identifier with a winning score and may thereby determine a winning player. The server 102 may then cause that tournament voucher to be redeemable in the gaming property 100 for a cash prize.

In another embodiment, the server 102 may receive information from the gaming device 104 indicative of a player that has received a winning score. For example, if a player club card has been read at the gaming device 104, a player identifier encoded on the player club card may be forwarded with the winning score. The server 102 may then associate the winning player with a player account at the gaming property 100, and the server 102 may then automatically credit the player account with the cash prize awarded to the winning player.

In one embodiment, a value of the cash prize awarded may be based at least in part on the tournament fees charged. Thus, the gaming property 100 may ensure that the cash prize does not exceed the monies received in tournament fees. For example, the value of the cash prize awarded may be equal to some percentage of the tournament fees received.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any processor-related system or method. In the context of this document, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any means that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a nonexhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A system for enabling tournament play in a gaming property, comprising:
a plurality of gaming devices, each of the plurality of gaming devices including a game display and configured to enable play of at least one game of chance;
a server coupled to the plurality of gaming devices, the server including:
a processor that executes instructions; and
a computer-readable memory that stores instructions that cause the processor to enable tournament play by:
initiating a tournament having a tournament duration within the gaming property;
causing tournament icons to be displayed on the game displays of the plurality of gaming devices during play of the at least one game of chance;
enabling play of a tournament game associated with the tournament at the plurality of gaming devices, the tournament game comprising a timed tournament session shorter than the tournament duration;
receiving tournament scores achieved in the tournament game during the tournament duration from the plurality of gaming devices;
comparing the tournament scores; and
determining a winning player based at least in part on the comparison; and
a display board coupled to the server, the display board viewable by players of the plurality of gaming devices and configured to display at least one of the tournament scores during the tournament duration.

2. The system of claim 1, wherein each of the plurality of gaming devices further includes a printer configured to print tournament vouchers including a tournament score.

3. The system of claim 2, wherein at least one of the tournament vouchers is redeemable for a cash prize.

4. The system of claim 1, wherein each of the plurality of gaming devices further includes a currency acceptor and is configured to charge a tournament fee upon selection of the tournament icon.

5. The system of claim 1, wherein the tournament game is different than the at least one game of chance.

6. The system of claim 1, wherein each of the plurality of gaming devices further includes a player club card reader configured to read a player club card issued by the gaming property, and wherein the computer-readable memory of the server stores further instructions that cause the server to associate the winning player with a winning player account at the gaming property based at least in part on a winning player club card read by at least one of the plurality of gaming devices.

7. A computer-implemented method for enabling tournament play in a gaming property, the method comprising:
initiating a tournament having a tournament duration at a gaming property;
enabling play of a tournament game associated with the tournament at a plurality of gaming devices in the gaming property, the tournament game comprising a timed tournament session shorter than the tournament duration;
receiving tournament scores achieved in the tournament game during the tournament duration from the plurality of gaming devices;
comparing the tournament scores; and
determining a winning player based at least in part on the comparison.

8. The method of claim 7, further comprising awarding a cash prize to the winning player.

9. The method of claim 8, further comprising charging tournament fees at the plurality of gaming devices in order to play the tournament game.

10. The method of claim 9, wherein a value of the cash prize is based at least in part on the tournament fees.

11. The method of claim 8, further comprising printing tournament vouchers at the plurality of gaming devices, each tournament voucher including a tournament score.

12. The method of claim 11, wherein at least one of the tournament vouchers may be redeemed for the cash prize.

13. The method of claim 7, wherein enabling play of the tournament game further comprises displaying tournament icons on the plurality of gaming devices during the tournament duration.

14. The method of claim 13, wherein at least one of the tournament icons is displayed while a non-tournament game is played on at least one of the plurality of gaming devices.

15. The method of claim 14, wherein the tournament game is different than the non-tournament game.

16. The method of claim 7, further comprising displaying at least one of the tournament scores on a display board in the gaming property during the tournament duration.

17. The method of claim 7, wherein the tournament game comprises a game of chance.

18. A server for enabling tournament play in a gaming property, comprising:
a processor that executes instructions; and
a computer-readable memory that stores instructions that cause the processor to enable tournament play by:
initiating a tournament having a tournament duration at a gaming property;
enabling play of a tournament game associated with the tournament at a plurality of gaming devices in the gaming property, the tournament game comprising a timed tournament session shorter than the tournament duration;
receiving tournament scores achieved in the tournament game during the tournament duration from the plurality of gaming devices;
comparing the tournament scores; and
determining a winning player based at least in part on the comparison.

19. The server of claim 18, wherein enabling play of the tournament game further comprises causing tournament icons to be displayed on the plurality of gaming devices during the tournament duration.

20. The server of claim 19, wherein at least one of the tournament icons is displayed during play of a non-tournament game on at least one of the plurality of gaming devices.

21. The server of claim 18, wherein the computer-readable memory of the server stores further instructions that cause the server to cause at least one of the tournament scores to be displayed on a display board in the gaming property during the tournament duration.

22. The server of claim 18, wherein the tournament game comprises a game of chance.
